(19) United States
(12) Patent Application Publication
(10) Pub. No.: US 2007/0061041 A1
(43) Pub. Date: Mar. 15, 2007

(54) Mobile robot with wireless location sensing apparatus

(76) Inventor: Stephen Eliot Zweig, Los Gatos, CA (US)

Correspondence Address: STEPHEN E. ZWEIG, 224 VISTA DE SIERRA, LOS GATOS, CA, 95030, US

(21) Appl. No.: 11/515,573

(22) Filed: Sep. 5, 2006

Related U.S. Application Data
(63) Continuation-in-part of application No. 10/654,540, filed on Sep. 2, 2003.
(60) Provisional application No. 60/834,616, filed on Jul. 31, 2006.

(51) Int. Cl. G06F 19/00

(52) U.S. Cl. 700/245

(57) ABSTRACT

A robotic navigation system for computerized mobile robot. Typically the robot, which may be in an unknown location, will have an onboard internet web server, a capability of establishing a first connection to a remote web browser on the internet for robotic control purposes, and a capability of establishing a second short range bi-directional digital radio connection to one or more nearby computerized digital radio equipped devices external to the robot. Typically at least some of these nearby digital radio equipped devices will have a known location. The robot can exchange short-range bidirectional digital radio signals with nearby devices that have a known location, and obtain location data to determine it's position. This location information can be used to assist in robotic navigation. The robot can also navigate to other objects, which also may have an unknown location, using a similar technique in which the object with an unknown location exchanges short range bidirectional digital radio signals with either the robot itself, or other digital radio linked devices with a known location (which then relay the object's location to the robot).

This application claims priority benefit of, and is a continuation in part of, application Ser. No. 10/654,540. Ser. No. 10/654,540 claimed the priority benefit of application Ser. No. 10/047,574 “Mobile robotic with web server and digital radio links”, filed Jan. 14, 2002, and since issued as U.S. Pat. No. 6,658,325. Application Ser. No. 10/047,574 in turn claimed benefit of provisional patent application 60/261,741 “Mobile robotic system with onboard internet web server, and short-range bi-directional digital radio links to external computerized devices”, filed Jan. 16, 2001. The application additionally claims priority benefit of provisional patent 60/834,616, “Mobile robot with wireless location sensing apparatus”, filed Jul. 31, 2006.

### BACKGROUND OF THE INVENTION

1. Field of the Invention

The invention relates to means by which mobile robots may precisely locate themselves, navigate, and target objects with high precision using location technology based on short-range digital wireless links. Such robots can be directed to precisely locate various targets of interest, and accurately move to these targets. This technology is particularly useful for telemedicine applications, in which the robots are controlled by healthcare workers over the Internet, and are used to interact with patients and medical equipment, and find medical supplies.

2. Description of the Related Art

One problem that hinders more widespread adoption of robotics technology is navigation technology. Robotic navigation from location to location, and robotic detection and movement to objects which may be in an unknown location, can require sophisticated vision systems considerably more capable than present automated vision detection systems. As a result, non-visual robotic navigation technology continues to be an important alternate way to achieve robotic navigational needs.

Although such improved robotics navigation systems can be used for a broad variety of different robotics applications, including military applications, vehicle navigation, factory automation, agriculture, security, and home automation, it is impractical to discuss all possible applications simultaneously. As a result, in this disclosure, robotic medical and telemedicine applications will be used as specific application examples. It should be understood, however, that this particular application is simply one of many applications where improved robotics navigation technology can be useful.

Review of Robotic Healthcare and Telemedicine Technology

Modern medicine, and nursing in particular, is facing a demographic crisis, particularly in the United States and Europe. There is a large cohort of aging baby boomers that will require an increasing amount of attention for the foreseeable future. At the same time, there are fewer young workers entering nursing. As a result, the entire healthcare community, and particularly nursing, will need to find ways cope with this increasingly unfavorable nurse-to-patient ratio.

Although, in other fields, automation has a good track record of enabling a smaller number of workers to handle an increasing amount of work, these efforts have been less successful in nursing. The job is extremely complex, requiring the nurse to move through constantly changing healthcare facility environments in order to locate patients and materials, and make rapid on-the-spot decisions requiring a lot of judgment. Additionally, any attempt to automate or streamline nursing must take into account the beneficial effects of a one-on-one nurse-patient relationship.

The demographic crisis will not go away, however, and at the same time, advances in modern electronics continue to make automation increasingly cost effective and sophisticated.

There have been a number of previous attempts to produce nursing or health care robots. One company that is presently active in this field is ‘InTouch-Health” of Goleta California InTouch-Health produces the RP-7 Remote Presence Robotic System. This system allows a healthcare worker to direct a RP-7 robot through a healthcare facility by way of a WiFi short-range radio link to a remote computer station. The RP-7's operator can control the robot as it roams through a healthcare facility by way of a web browser and joystick on the remote computer station. The operator can also project an image of himself or herself through a display on a screen mounted on the robot.

Although one-on-one teleconferencing is indeed desirable, nursing involves much more. One particularly time-consuming part of the job is finding people, and finding medical supplies, followed by bringing the people and medical supplies to particular locations. For example, a patient many need to be located and directed to go to a room for therapy. Pills or medication need to be located, and given to a patient. A second time-consuming part of the job is reading medical equipment and adjusting medical equipment. In this case, a medical sensor may need to be read, or a bed or other equipment adjusted.

A nurse's time must be leveraged, however. A nurse spending his or her time maneuvering a single prior-art robot using a joystick is almost certainly less productive than a nurse without such a robot. In order for a robotic system to actually leverage scarce nursing resources, a nurse should be able to control multiple robots simultaneously, and the tedious task of locating people and things needs to be automated. Ideally, the nurse should be able to issue high-level commands to the robot such as: “find equipment z,” “bring patient x to location y,” “bring medicine x to patient y,” “read instrument q,” “adjust equipment p”. The nurse should then be able to turn her attention to other matters while each robot automatically carries out its particular task.

Several things are needed in order to make this concept workable:
1: Technology is needed that enables robots to automatically find a wide variety of things (people, medication, equipment) that usually don't have a fixed location.
2: Robotic control methods are needed which are easy to use, and extremely flexible.
3: The hardware and software modules used should be very low-cost, very robust, and essentially “off the shelf.” The robot should be inexpensive enough (both in cost per robot and added institutional infrastructure) as to make economic sense.

Although self-propelled mobile robots have been the subject of speculative literature and experimentation for a number of years, the field is still in its infancy. With the partial exception of industrial automation for highly repetitive situations, educational purposes and toys, and the previously discussed RP-7 healthcare robot, mobile robots are not widely used. This is because the problems of coping with machine vision, artificial intelligence, general purpose robotic “arm” and “hand” like actuation systems, limited battery life, and the like make it difficult to devise flexible and general purpose systems suitable for widespread use.

Because robotic artificial intelligence is particularly difficult to achieve, human operators often remotely control robots. A number of techniques for robotic remote control (teleoperation) are known in the art, and these are discussed in the book: “Remote Control Robotics” by Craig Sayers, published by Springer-Verlag, N.Y., (1998) and incorporated herein by reference.

Other prior art includes U.S. Pat. No. 4,964,062, which teaches a type of robotic arm that may be controlled by radio from a remote location, and may be programmed by radio from a remote location. U.S. Pat. No. 5,331,413 describes an external camera used to view a robot. U.S. Pat. Nos. 5,231,693 and 5,046,022 describe methods of semi-automating telerobotic control. U.S. Pat. No. 6,144,844 describes methods to compensate for variable teleoperation delay.

Prior art for robotic navigation technology includes U.S. Pat. Nos. 5,940,346 and 6,674,687 which teach acoustic navigation techniques; U.S. Pat. No. 7,079,924 which teaches vision navigation techniques, and infrared navigation techniques such as the Evolution Robotics “NorthStar™” system, which a robot navigates by observing infrared light spots projected on the ceiling, disclosed in U.S. provisional applications Nos. 20050211880, 20050213082 and 20050213109.

Zigbee wireless radio location engine technology is taught by D Taubenheim, S Kyperountas, N Correal. “Distributed Radiolocation Hardware Core for IEEE 802.15.4,”8 Dec. 2005, Motorola Labs, Plantation, Florida, USA; and by K. Aamodt. “Chipcon Products from Texas Instruments, CC2431 Location Engine, AN042”, Texas Instruments, 2005.

This Zigbee location engine technology uses the signal strength of the radio signal values from known reference nodes to deduce relative locations.

For robotic navigation purposes, the wireless control technology originally developed for internet controlled robots, originally disclosed in provisional application No. 60/261,741, and subsequently discussed in more detail in copending application Ser. No. 10/654,540, as well as in commonly owned U.S. Pat. Nos. 6,658,325 and 7,096,090, can be highly useful. This technology is incorporated into this disclosure herein by reference, and to facilitate discussion, portions of this are discussed and restated below.

Mobile Robots with Web Servers and Digital Radio Links

Recently, programming techniques used to increase the power and flexibility of the Internet have matured, and a number of these newer programming techniques can also be adapted to robotic control methods. In particular, this includes programming languages, interfaces, and protocols used to generate (serve) and interpret (browse) World Wide Web pages on the Internet.

World wide web (also called “Web” or “Net”) servers are computer programs, such as “Apache”, and the like, that communicate over the internet in the form of variants of Standard Generalized Markup Language (SGML), such as Hypertext Markup Language (HTML), Extensible Markup Language (XML), Extensible HTML (XHTML), Dynamic HTML, and the like. These servers accept commands from a remote user, and respond by returning SGML variant “web pages” or forms, which can be read and interpreted by the remote user's browser.

Data is transferred over the Internet through a series of “routers”, where each router acts to receive a data packet from one part of the network that the router is connected to. The router examines the destination address of the data packet, consults the router's memory to determine the router's current understanding of the network configuration, and then sends the data packet along to another router that will normally bring the data closer to the final destination address. Alternatively, if the router is directly connected to the final destination, the router will send the data packet directly to the final destination.

For purposes of this discussion, “web page” is defined as an SGML variant, HTML, XML, or XTML electronic document on the World Wide Web, identified by a unique Universal Resource Identifier (URI) or unique Universal Resource Locator (URL), and transmitted over the Internet using the TCP/IP protocol. Usually, but not always, such pages are also transmitted using the HTTP protocol as well.

Also for purposes of this discussion, “web server” is defined as computer program functionality (either stand alone, or part of an operating system) that, in response to an internet URL or URI request, sends back a “web page” file to the internet address that made the request, or alternatively passes the URL or URI request through a “Common Gateway Interface” or CGI like protocol to a CGI compliant program, or equivalent, and when the CGI compliant program has output, and passes the output back to the internet address that made the original URL or URI request.

In addition to familiar web pages based upon variants of SGML and the HTTP protocol, other TCP/IP data transmission protocols can also be used. In general, any data packet type that is transmitted by the TCP/IP protocol is suitable, and any compatible TCP port can be used. In addition to the HTTP transfer protocol, other TCP/IP transfer protocols and URLs such as gopher, mailto (email), news, nttp, telenet, wais, etc. may also be used. In general, any protocol and internet protocol (IP) datagram and IP header field that transmits data packets over the internet can be used for the present art, since these data packets can always be reassembled by the receiving program and reformatted according to user or system preference. Thus for example, a “web page” could be transmitted by nonstandard means, such as the mailto (or email) protocol, and used or reformatted by the receiving program to accomplish essentially the same functions as a webpage sent by the HTML protocol.

Use of the CGI interface, or equivalent interface, greatly enhances the flexibility and power of web/server—SGML variant web form technology. Here, the HTML or SMGL variant web form can be instructed to pass data of any sort to and from the user to programs, executable scripts, or software processes that are distinct (external) from the main web server program. This non-web server software may be a database, image manipulation program, robot control program, or any other independently running process. Data submitted from a web browser to a web server's CGI interface is generally submitted either appended to a CGI URL address (GET method, limited to 255 maximum characters of data) or through a STDIN standard input method (POST method, no data size limitation). Data from a web server to a web browser may be of any sort, as long as it complies with the Multipurpose Internet Mail Extensions (MIME) format.

Prior art on the GCI interface includes U.S. Pat. Nos. 6,041,362; 5,961,594; 5,905,908; and 5,742,845. A more complete CGI discussion is given in Dwight, Erwin and Niles book: “Using CGI, Second Edition”, 1997, published by Que corporation, and incorporated herein by reference.

In addition to SGML variant files (HTML, XML, XHTML, etc.), programming languages such as Java are also frequently transmitted by servers on the word wide web. Java (and Java-like languages such as C#), is a general purpose, object oriented, high level programming language, commonly used on the world wide web to deliver enhanced functionality to web pages. Typically Java commands are embedded in SGML variant files that frequently sent out (and occasionally also received) by web servers. Such Java “applets” can then perform many specialized functions. In particular, Java applets may be used to extend the basic SGML functionality, and can translate user commands to other languages, display video, display interactive graphics, and other useful functions.

Web browsers are likewise commonly known in the art. For the purposes of this patent, a “web browser” is considered to be a program that can read and interpret the SGML variant files sent out by web servers, (primarily HTML files) and optionally execute Java and/or additional plug-in module commands. Examples of modern web browsers include Microsoft Internet Explorer 5.0 or greater, Mozilla Firefox 1.0 or greater, and the like.

For robotics control purposes, in order to take advantage of the wide variety of “off-the-shelf” software, originally written for internet or other purposes, for robotics control, it is preferable to use software (programs) that run on standard operating systems, rather than software that attempts to run directly on the underlying robotic computer hardware. Standard operating systems, such as Windows, Linux, Unix, and the like, manage much of the software burden of a computational system by controlling access to underlying hardware, memory management, and the like, relieving the programmer of much complexity.

Popular (e.g. widely used) multi-tasking operating systems are particularly advantageous, since thousands of programs are available that have previously been written for them. By use of a popular operating system, a robotics programmer may leverage his or her limited time and energy by using standard programs to handle most of the robotics system, and only writing robot specific software when absolutely necessary. Using these operating systems, a robotics software developer need not directly address the robot's underlying hardware, but rather can simply write programs that interact with the operating system. This reduces or eliminates the need to rewrite these programs for different robot hardware configurations.

The one drawback of this approach from a robotics control standpoint is some potential loss or degradation of precise real-time determinism and control, which can be overcome by the use of real-time modifications or patches to such operating systems. An example of a popular operating system (Linux), modified to enhance real-time determinism and control, is taught by U.S. Pat. No. 5,995,745 for “real time Linux”. Other such real-time operating system enhancements also exist.

Previous art teaches that both mobile and non-mobile robots may have their movement and video functions controlled remotely by using web browser/web server technology. In addition to the InTouch-Health RP-7 robot previously discussed, Intelligent Autonomous Systems Engineering Laboratory of the University of the West of England, Bristol teaches that web server technology may be used in mobile robotic systems. They have developed the “LinuxBot”. This is a mobile robot, intended as an educational project, that performs a number of functions, including movement and wall avoidance, as well as serving web pages, using an on-board multitasking embedded Linux operating system environment with a wireless link to a local area network. The robot has no “arms” or other actuators, nor other means to control other external computer controlled devices. Its primary purpose is as an academic training device.

iRobot Corporation of Somerville, MA produced the “iRobot-LE”, a mobile robot containing an onboard computer running an “apache” web server under the Linux operating system. Users may remotely control this system over the Internet using standard web browsers. Because the device contains neither robotic “arms” other actuators, or means to control other external computer controlled devices, it has limited practical utility.

A number of examples of non-mobile robotic systems, such as robotic arms controlled by remote web browsers over the Internet, also exist. Some of these are documented in Chapter 4 of the previously discussed “Remote Control Robotics” reference. Typically these are demonstration systems that can move a few test items, or perform some other limited chore. Other examples include different types of robotic telescopes. In one implementation, a remote viewer using a standard Internet browser positions a robot telescope. The telescope is commanded by a version of XML called AMIL (Astronomical Instrument Markup Language), which is interpreted by a Java program running locally on the robotic telescope.

Although such prior art is useful for situations in which self-mobile robots are used to directly interact with their local environment, or in which peripheral devices attached to non-mobile robots are remotely controlled over the internet, there exist situations in which it is desirable to extend the functionality of a web browser/server controlled mobile robotic system beyond those peripherals that are directly connected to the robot. In particular, there are situations where it is desirable to bring a capable mobile robot close to a particular location, use the sensors onboard the robot to observe local conditions, and then manipulate one or more additional devices in the location that would otherwise be impractical to control by direct manipulation by the robots onboard arms, manipulators, etc.

For example, there may be situations where it is desirable to employ a mobile robot for patient monitoring functions in a multi-patient facility, or as a security guard. Here, the robot may be given a general route to travel by a remote Internet operator, as well as standing orders to observe its surroundings by its onboard camera, and check and adjust the status of various external robotic cooperative monitors. The remote internet operator may also wish to leave standing orders for the robot to travel different routes, open robotic cooperative doors, sound robotic cooperative alarms, etc., depending upon the data that is received from the external monitors.

As a second example, there may be situations where it is desirable to employ a mobile robot to monitor and adjust robotic cooperative equipment in a home or institutional healthcare environment, or in an industrial or laboratory facility. Here, the robot would be given general routes to travel by one or more operators over the Internet. The robot would travel the specified routes, check the status of external equipment monitors, and additionally modify the state of the external equipment, using various standing orders that the remote operators may have left. Such a system would be particularly useful in a flexible manufacturing industrial setting, monitoring geriatric patients in a nursing home, or in a laboratory, where many operators, residing in many remote locations, have a desire to use the equipment on a time-share basis.

In a third example, the mobile robot of this invention might be used in a home situation to travel throughout the home and observe pets, children, or elderly people, and perform service functions such as fetching food from specially modified robotic cooperative refrigerators, cook food in robotic cooperative ovens, or process utensils or dishes in specially modified, robotic cooperative, dishwashers, garbage compactors, etc. Other home functions where such a robot could interact with specially modified, robotic cooperative, appliances include sprinklers to water plants, equipment to care for pets, cleaning equipment, heating and air conditioning equipment, security equipment, medical equipment, and the like.

For the purposes of this discussion, a “mobile” robot is considered to be a robot that moves on solid surfaces, water, or air due to the controlled action of onboard motors or mechanical actuators, such as motorized wheels, tracks, legs, propellers, jets, and the like. A robot that moves only by the application of outside force, even if portable and easily carried, is not considered to be “mobile”.

Because it is difficult to design a mobile robot with sufficient visual acuity or dexterity to work with a wide variety of human operated equipment, the problem may be considerably simplified if the requirement that the robot directly observe external sensors or directly manipulate external equipment is reduced or dropped. This may be done by modifying the external sensors or equipment to be “robotic cooperative” by having an ability to report their status, and be operated by, short range, bidirectional, digital radio links (abbreviated here as “SBDRL” for Short-range Bi-directional Digital Radio Link). If this is done, then the robot need only get close enough to the sensor or equipment to make radio contact with the external device. Once this is done, the robot may then ascertain the other device's status by short-range digital radio link, and optionally make additional observations or manipulations using the robot's own on-board equipment. The robot can then transmit its findings and receive commands from operators from any location throughout the world using inexpensive and commonly used Internet (web) browser systems to relay to the external device.

To achieve these objectives, it is desirable to give a web browser/server controlled mobile robot an additional capability to manipulate its local environment by sending and receiving bi-directional short-range digital radio signals that can be used to control or interact with local devices that are external to the robot. In this context, “local” and “short-range” are defined to be distances between about 0 and 300 feet.

Means to control various radio controlled devices by local digital radio links are known in the art. Although many different radio frequencies and digital encoding schemes can be used for these purposes, use of the 2.4-gigahertz (gHz) industrial-scientific-medical frequency band, which is internationally reserved for local digital links, and does not require a license, is particularly advantageous. It is also advantageous to use standard digital-encoding schemes, as this increases the variety of devices that the robot can communicate with.

There are a number of standard protocols for communicating digital information in the 2.4 gHz frequency, such as the Institute of Electrical and Electronics Engineers (IEEE) standards 802.11, and the IEEE 802.15 and 802.15b standard for personal area networks (PAN). The disclosures for these standards are incorporated herein by reference.

IEEE standard 802.11 discloses a set of local digital radio link protocols compatible with the HomeRF specification. The HomeRF standard, in conjunction with the Shared Wireless Access Protocol (SWAP), enables local low power digital 2.4 gigahertz radio communication with a range of up to 150 feet between devices. Up to 10 different devices may be networked within this radius.

IEEE standard 802.15 discloses a set of local digital radio link protocols compatible with the Bluetooth™ specification. (Bluetooth is a trademark of the Bluetooth special interest group). Bluetooth compliant low power digital radio systems can automatically establish very short range (0-30 feet) or longer short range (0-300 feet) wireless digital radio linkages with other Bluetooth compliant devices. Further discussion of the Bluetooth standard may be found in the book: “Bluetooth revealed” by Miller and Bisdikian, Prentice Hall PTR publisher (2000), and incorporated herein by reference.

IEEE Standard 802.15.4 discloses a set of local digital radio link protocols compatible with the Zigbee™ specification. Zigbee differs from Bluetooth in that it uses much less power, generally transmits less data, and has a vastly improved networking capability. Like Bluetooth™, Zigbee devices generally have a range of about 300 feet.

EPCglobal has proposed a number of different Radio Frequency Identification Tag (RFID tag) standards, which are relevant to this disclosure. These include the EPCglobal GS1 and GS2 (generation 1 and generation 2) standards for passive RFID tags. Unless otherwise stated, the term RFID and/or RFID tag will be used in this specification to stand for either active, battery assisted passive, or passive RFID tags.

Other relevant standards include the IEEE P1902.1 RuBee™ standard, which describes an ultra-low power, 450 KHz SBDRL tag with a range of about 10-50 feet.

Previous examples of remotely controlled robotic systems that use short-range digital radio links to control local peripherals include the 1996-1997 NASA Mars “Pathfinder” and “Sojourner” robotic system. In this system, a stationary robot (the Pathfinder) was controlled by unique NASA protocol using a long-range radio link to earth. The stationary Pathfinder robotic system then established a short-range digital link at 459 MHz with the mobile Sojourner robotic rover, and controlled its movement and sensors. The results were communicated back to earth using unique NASA transmission schemes. Because these techniques used nonstandard, non-SGML variant, non-HTTP protocols, complex, customized and expensive equipment and programs were required in order to correctly control the Sojourner robotic rover. The techniques and software used were not general purpose, and thus could not be used for purposes beyond controlling the specific system at hand.

There appears to no prior art teaching the use of mobile, Internet capable, web browser/server controlled robots to travel to nearby devices, and subsequently monitor and/or control the devices by use of bi-directional short-range digital radio links. Nonetheless, such devices would enable remote users to control sophisticated robotic systems using inexpensive and readily available equipment and software, and thus would be of significant practical utility.

### SUMMARY OF THE INVENTION

The present disclosure teaches an improved method of robotic navigation in which the robot first receives information about it's general location (which may not be presently known) by exchanging short-range bidirectional digital radio links with other local SBDRL devices that have a known location. The local SBDRL devices and the robot work together to determine the robot's approximate location by triangulation and by relative signal strength determination. The robot can also receive information about the general location of a target object (which also may have an unknown location) if the target object is also equipped to send and receive SBDRL radio signals with local devices of known location. If these local SBDRL devices are in turn networked together, such as by a Zigbee network, this location information may be passed to either the robot itself, or the robot's operator. The robot may thus be informed of both its own approximate location, as well as the approximate location of its target.

The approximate location of both the robot and its target can be defined with still more accuracy by combining data obtained from different SBDRL devices with different effective radio ranges. As an example, the robot may obtain still more position information by receiving SBDRL signals from various short-range RFID tags. This is because certain types of RFID tags, passive RFID tags in particular, can send signals for only a few inches to a few feet.

If the robot's target object is also equipped with one or more of these short-range RFID tags, the robot may further refine its knowledge of the location of the target object. That is, if the target object is equipped with an RFID tag that only transmits for about six inches, the robot will know, by looking for this particular RFID signal, if it is within about six inches of this particular tag (which in turn is affixed to the target object) or not. The robot may then use the information from this very short range RFID tag to either move closer to a target object, or alternatively back away from a target object that may be too close.

These techniques may be further combined with other techniques, such as Internet control techniques in which the robot acts as a web server to send web pages to remote Internet operators. The combination of the present disclosure's location detection techniques, with the SBDRL Internet control techniques of the parent application, allows remote operators to easily direct robots to move to different locations, and find targets (such as human patients), that may be moving, or may have a previously unknown location.

As previously discussed, this location technology can be used in many different applications, including military applications, vehicle navigation, factory automation, agriculture, security, home automation and healthcare applications. Here healthcare applications, in particular nursing telemedicine techniques, are used to exemplify some of these various potential applications, but are not intended to otherwise limit the scope of the invention.

### BRIEF DESCRIPTION OF THE DRAWINGS

FIG. 1 shows an example of a mobile robot, equipped with an onboard camera, that is controlled by a link to a remote Internet web browser, with an additional SBDRL link with two external devices. In this example, one external device is a non-mobile robotic arm, and a second external device is an external camera.

FIG. 2 shows an example of the software scheme used to control the robotic system shown in FIG. 1.

FIG. 3 shows a schematic of a specific robotic design.

FIG. 4 shows an overview of a nursing-assistant robot design.

FIG. 5 shows a schematic diagram of a combination Zigbee− RFID tag

FIG. 6 shows a robot finding a patient by way of a combination Zigbee+ RFID tag.

FIG. 7 shows how the Zigbee location engine technique works

FIG. 8 shows a floor plan style robotic control web page.

FIG. 9 shows a robotic telepresence web page for “face to face” patient meetings.

FIG. 10 is a diagram showing how the various hardware modules are linked together in the robot.

FIG. 11 shows how the robot's software is configured.

### DETAILED DESCRIPTION OF THE INVENTION

At present, mobile robots and robotic systems tend to be inflexible, specialized, and expensive. In order to bring the advantages of robotic automation into more general use, robots must be designed that are simple, low-cost, and general purpose. Such robotic systems can be can be constructed according to the principles disclosed herein. This can be done by combining the flexibility and generality of Internet technology, with mobile, capable, and general-purpose robots, and multiple SBDRL external peripherals that are optimized to address specific tasks.

In the broadest sense of the invention, the “robot” disclosed here is a self-propelled mobile internet server with a capability of establishing both a first connection to the internet for robotic control purposes, and a capability of establishing a second bi-directional digital radio connection to one or more local digital radio devices that may not be themselves directly connected to the internet, and which usually have a maximum radio range of about 300 feet. In a preferred embodiment, this short-range wireless digital connection will use the 2.4 GHz band and digital protocols following the IEEE 802.11, 802.15, RFID, RuBee, or other digital communications protocol. By employing the proper set of external short-range digital radio devices capable of interfacing with the robot, a system of considerable practical utility can be devised.

As will be disclosed here, the combination of wireless technology, with common WiFi Internet web server/web browser technology, enables simple robots to be constructed that can perform many “go find and fetch”, “read and adjust” and “go talk to patients” type functions. These robots, which can be operated from any web browser in the world, could help alleviate nursing labor shortages in both home and institutional settings by liberating nurses from time-consuming travel and “gofer” activities.

Modern electronics enables robots of this type to be constructed from simple modular off-the-shelf components. The software is also comparatively simple, modular, and off-the-shelf, because from the software perspective, the robot is essentially a mobile Internet web server, using standard web server software components. Remote users can control the robot through interacting with the robotic web pages. Since, with this system, there needs to be no geographic link between the healthcare professional and the patient, the resulting flexibility offers the possibility of significant improvements in overall efficiency.

This disclosure teaches how to produce a robotic nursing-assistant. Since the robot is web based, and is controlled by a standard Internet web browser, the user interface can be optimized for a healthcare setting.

More specifically, the present disclosure teaches a demonstration robotic nursing assistant that addresses some of the more tedious and time consuming parts of nursing—that of finding things, getting things, giving information to patients, and getting information from patients.

This robotic nursing assistant somewhat resembles other common hospital equipment on wheels, such as IV poles and blood pressure monitors. The robot contains a web server and a WiFi connection to the Internet, is capable of independent movement, and can be controlled from a nurse's station (either local, or at a different site) through a standard Internet web browser. The robot also has an ability to form local wireless connections with other local wireless devices, such as RFID tags, Bluetooth devices (such as Bluetooth controlled medical equipment), and Zigbee networks.

As previously discussed, Zigbee is a new type of inexpensive electronic chip for forming short-range wireless radio links. A Zigbee chip can spontaneously form local radio networks with other Zigbee chips, and these chips can then use this network information to physically determine where one Zigbee chip is relative to other Zigbee chips. In this disclosure, standard Zigbee chip “location engines”, in conjunction with RFID chips, are used to enable nurses to determine exactly where the robot and other Zigbee tagged items (such as patients, medical supplies and equipment) are. Since the robot can be hooked up to the Internet through its onboard web server, the robot can transmit web pages showing exactly where the robot and tagged items are located. A nurse can thus direct the robot, through its web browser interface, to quickly find both patients and supplies.

The robot is also capable of conducting two-way video conversations between nearby patients and the remote nurse. The signal from the patient to the nurse is done by a conventional wireless webcam mounted on the robot. The signal from the nurse to the patient can be less direct—nurse's signal to Internet, to WiFi link, to robot, which is then retransmitted by a wireless Bluetooth transceiver on the robot to a local Bluetooth receiver near the patient. This Bluetooth receiver can be a standard Bluetooth audio headset (for patient privacy), a Bluetooth cell phone, a Bluetooth PDA with a small screen (mounted on the robot), or other Bluetooth audiovisual system near the patient.

The present teaching allows nurses to conduct effective remote robotic (telemedicine) “home visits”. Additionally, nurses in multi-patient facilities can leverage their time by controlling many robots simultaneously. This multi-tasking is possible because the robot's Zigbee/RFID location engine enables the nurse to issue high-level “goto” and/or “fetch” commands. The robot knows where things are, and is able to run automatically. At any point, the nurse is able to examine a given robot's local situation through the robot's webcam, and be able to interact with patients and/or adjust equipment as needed.

It is contemplated that the self-propelled mobile Internet server robot will generally serve SGML variant web pages that are designed to be read by humans, and work with standard Internet web browsers under direct human control. However for greatest generality and usefulness, direct human control is not strictly required. Human readable SGML variant (typically HTML) web pages can also be scanned, parsed, and interpreted by automated techniques. Depending upon the situation at hand, it may be advantageous to parse the web pages automatically at a remote site, and remotely control the robot by remote computational resources, (standard computer microprocessors, supercomputers, computer clusters, and the like) that are more sophisticated than the robot's own onboard computer.

The robotic system disclosed here may be controlled by three different general methods. These control methods are local robotic control, remote automated control, and remote human control. Local robotic control would typically handle routine, simple, or fast response time tasks that are best done by executing previously stored instructions using the robot's onboard computing facilities. Remote automated control would typically consist of standardized but more computationally challenging tasks, such as sophisticated computer vision, sophisticated robotic control algorithms, etc., best handled by larger and more sophisticated remote computational resources specialized for these purposes. Rarely occurring (non-routine) tasks, complex tasks, or other tasks requiring human judgment would then be handled by humans using remote internet browsers that read standard HTML or SGML variant web pages served by the robot's onboard web server.

Allowing either remote human and remote computer judgment to be used depending upon the situation increases the scope and flexibility of the robotic system. This is desirable because it enables large numbers of such systems to mass produced for a variety of different uses, leading to a lower per-unit cost for each system.

It is anticipated that the robot would receive its most general (highest level) commands from the remote Internet link. However there may often be situations where it is advantageous to enable the robot to interpret and modify these top-level commands in a quick, real-time manner, depending upon the state of the robot's sensors and local conditions. In other situations, the robot may be used to perform repetitious tasks that fit within the capability of the robot's onboard computer processor.

For example, a robot may be given a remote command over the Internet to move forward a number of feet. However if a contact sensor or RFID tag sensor on the robot shows that the robot has encountered an unseen obstruction or is too close to a target, the top-level internet command may be modified by contingency software running on the robot, and the robot's path may be modified or the robot stopped. As another example, a robot may be given an Internet command to grasp an object. The robot may interpret this command by use of its local on-board vision processing to ensure that its mechanical manipulators are properly positioned, etc. In still another example, a robot may simply move over a preprogrammed path in a repetitious manner.

For greatest flexibility, the robotic software should be designed to enable the remote Internet controller to upload new automatic instructions or scripts to the robot. These uploaded automatic commands will typically be used to control the robot when the remote user is off-line, when extremely rapid action is required, or when a complex series of actions is required. In addition to robotic control instructions, these instructions may also include an automatic series of commands to query SBDRL devices, and commands to send to various SBDRL devices.

These local automatic robotic control instructions (or scripts) may be written in a wide variety of formats and languages. These may include anything from simple text commands, to complex binary programs. Since many such local control instructions are possible, each potentially quite situation specific, automatic control instructions written in formats that facilitate rapid development and deployment, preferably by automated means, are preferable. Examples of preferred formats for rapid development and deployment instructions include XML scripts, PERL scripts, JAVA applets, and the like.

In addition to flexible remote control methodology, it is also desirable to give a robot flexible means to interact with its local environment. Here, some deviations from prior art are advantageous.

Prior art generally teaches that mobile robots primarily interact with their environment through sensors and mechanical actuators (robotic arms, and the like) located on the robot itself. However this is not always desirable. Using onboard mechanical actuators as the sole means to interact with the robot's environment can add significant cost and weight to the robot. Such mechanical systems can also make considerable power demands on a robot's onboard battery, which will typically have only limited power capacity. An additional problem is that it is difficult to design on-board robotic mechanical manipulators that can function well in a wide range of situations. Robot design constraints, such as limited size and battery life, may require that the robot's onboard mechanical manipulators have limited dexterity or lifting power.

To enhance flexibility and generality, it is advantageous if the mobile robot is designed with general means to interact with various external sensors, external mechanical manipulators and external appliances. The robot may then travel into range of the external devices, and call upon them to assist the robot at the task at hand. For example, a family of external, fixed position, mechanical manipulators, controlled by a local SBDRL link, can be used in combination with the Internet connected mobile robot to accomplish various tasks. Here, an external, non-mobile set of arms could load and unload items from a carrying tray on the robot, and the like. The robot can use its onboard sensors to monitor the progress of the operation, and to relay commands from the remote Internet operator to the external mechanical manipulators.

In addition to external mechanical manipulators, it is also advantageous if the mobile robot is designed to use SBDRL means to interact with local appliances. Examples of appliances which might be upgraded to add SBDRL capability for these purposes include industrial and laboratory processing equipment and medical equipment, as well as household appliances such as refrigerators, ovens, dishwashers, washing machines, clothes dryers, lights, sprinklers, floor cleaners, lawnmowers, security system, audiovisual systems, pet feeders, heating/air conditioning systems, automatic doors, and the like.

To enhance flexibility and generality, it is also advantageous if the mobile robot is designed with general means to interact with various external sensors. This may include SBDRL capable local vision systems, location detection systems, and other local sensor systems.

Vision systems: Although it is advantageous for a mobile robot to have its own onboard vision system, which can relay its activities and position to remote human or computer control systems, such on-board vision systems suffer from a limited field of view. This can make it particularly difficult for remote human or automated vision systems to control the robot. This problem can be alleviated by the use of external SBDRL vision systems. Such systems can be mounted in more advantageous places, such as the ceiling of a room, which can give a wider field of view. Alternatively, such systems can be mounted in such a way; such as with a microscope attachment, that can give the robot a more detailed field of view.

As an example, a robotic system moving into a room that has a SBDRL vision system on the ceiling will receive a more global perspective of its surroundings. The robot can then internally process this new perspective, or alternatively transmit the new perspective to a remote Internet control site, to assist in robotic control.

Many other types of external sensors are also be linked to a mobile robot by short-range digital links. These include environmental sensors, process sensors, chemical sensors, and the like.

One useful type of sensor is an object-reporting sensor, such as a radiofrequency identification tag (RFID tag). Such tags may contain a memory cache containing useful information, such as the object identifier, expiration date, and other characteristics.

Discovery of locally available SBDRL devices: Although in some situations, the distribution and functionality of the various external SBDRL devices will be known to the robot or the remote operator before the robot moves into proximity of the device, in other situations, this will not be previously known. In these later situations, where the distribution and functionality of the SBDRL devices is not previously known in advance, it is advantageous if the robot and the SBDRL devices are equipped to enable automatic discovery of the nature, functions, and services provided by each device.

A number of schemes to enable automatic discovery of the nature, functions, and services of remote devices are known in the art. This includes schemes such as “Jini™”, Universal plug and play™, Salutation™, Service Location protocol, etc. One scheme, particularly useful for “Bluetooth” (IEEE 802.15b) type devices makes use of the “Service Discovery Protocol”. Briefly, Bluetooth type SBDRL devices may maintain a service registry consisting of both device identifiers, and functions of the device that are available for use over the SBDRL link. Upon SBDRL query, if the device has its' discovery functionality enabled, this information is made available to the inquiring device.

By querying such SBDRL service registry information, and either processing it using the robot's own onboard computer processor(s), or passing the information along to a remote controller on the internet, SBDRL devices not previously known to the robot and/or its remote internet operator may be utilized. This greatly increases the flexibility of the robot, and thus use of SBDRL devices that enable remote discovery of their nature and services is generally preferred. To better facilitate cooperation with other external devices, the robot itself may also maintain a discoverable SBDRL “service discovery protocol” describing the robot's own nature and useable functions.

For other situations, such when the SBDRL is a relatively simple RFID tag, the signal from the robot to the tag may be used to power-up the tag, either through the energy from the robot's radio signal, or through a simple digital “1” sent from the robot to the SBDRL RFID tag. In either case, the robot's message to the SBDRL unit can be as simple as an “I am in close proximity, start transmitting”, which is equivalent to a digital “1”. By contrast, the lack of robot close proximity can be considered to be a digital “0”.

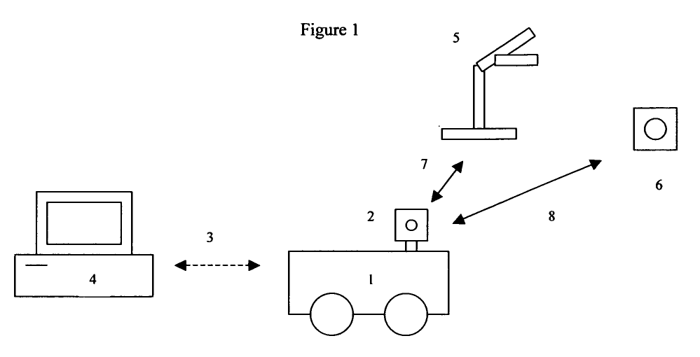

Examples of robotic systems constructed according to the concepts taught in the parent application are shown in FIGS. 1, 2, and 3.

FIG. 1 shows the general hardware scheme, employing a single mobile robot and two exemplary external SBDRL devices. A mobile robot (1), equipped with its own onboard camera (2), sends HTML files using the HTTP protocol on telecommunications link (3) to a web browser running on remote internet site (4). In response to CGI data sent back from the user on web browser (4) to the CGI interface of the robot's onboard web server, as well as the robot's own onboard commands, the mobile robot (1) moves into close proximity with SBDRL enabled external devices, such as a external robotic arm (5) and a external camera (6). The mobile robot (1) uses SBDRL radio signals (7), (8) to discover the presence and functionality of the robotic arm (5 and camera (6). The robot relays information from its own onboard camera (2) and the external camera (6) to remote Internet browser (4). The remote user may then direct the robot to send SBDRL signals to control the movement of external robotic arm (5). In one application, the external robotic arm might load objects onto the robot for subsequent transport elsewhere.

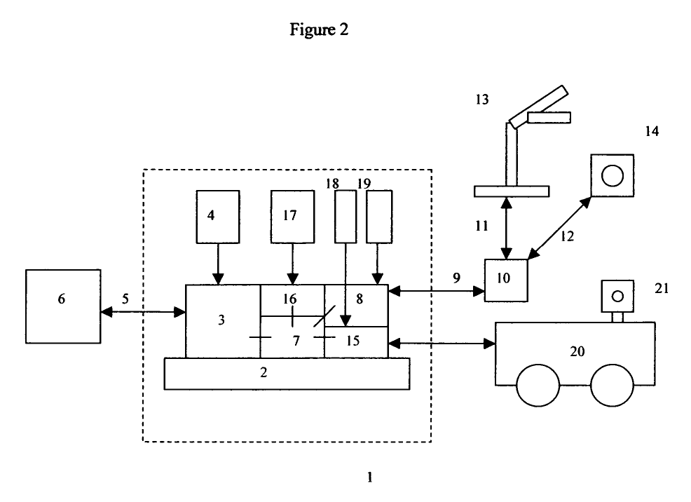

FIG. 2 shows the general structure of the software (1) onboard the robot. The robot's computer processor is typically controlled by a multitasking operating system (2)(usually a real-time operating system, or a variant of a general purpose operating system such as Linux), which either runs a separate web server software process (3), or else intrinsically has web server functionality as part of the operating system (3). The web server (3) is able to read HTML files (4) stored in the robot's onboard memory, and transmit them via long-distance telecommunications link (5) and HTTP protocol to remote web browser (6). Web server (3) also has CGI interfaces (7). These CGI interfaces are capable of sending and receiving data from most or all of the other software processes running onboard the robot.

Also running on the robot's operating system (2) is SBDRL interface software (8) to handle input/output (9) from the robot's onboard SBDRL transceiver (10). This transceiver (10) is capable of establishing SBDRL radio links (11), (12) with external SBDRL devices (13), (14).

Additionally running on the robot's operating system (2) are robotics control software (RCS) (15) which controls various robotics hardware such as motion control motors, onboard sensors, onboard mechanical manipulators, power management, and the like. Also running (16) are additional JAVA, PERL, PYTHON, C, etc., interpreters and compilers as needed to run various control instructions.

In use, the robot's web server (3) establishes contact over communications link (5) with remote Internet browser (6). The robot's web server (3) transmits HTML file (4) to remote browser (6), and receives back requests for additional web pages and CGI commands (using either the GET or POST method) from remote browser (6). The robot's web server (3) directs the CGI commands through CGI interface (7) to various robotic programs or files, depending upon the robot's state and the nature of the commands sent from the remote browser.

Remote browser commands that are essentially requests for additional web pages (for example, a command to access a particular robotic function that has an interface on a different web page) are handled directly by the robot's onboard web server (3), which sends additional web pages from HTML file (4) back to remote browser (6). Remote browser CGI commands for general robotics intelligence or additional web page functionality (for example, to read from or update a robotic database) are passed through CGI interface (7) to other programs (e.g. database systems, such as SQL servers, and the like) (17) in the robot's onboard memory, also running under operating system (2). Other interpreters (JAVA, PERL, etc.) may optionally run these other programs (17), (16) as needed.

The Robot's interface with its local environment (e.g. robotic movement, sensors, actuators, power, etc.) is primarily handled by RCS software (15). The robotic SBDRL (input/output) links are handled by the short-range digital radio interface software (8). These programs (15), (8) can either run directly from operating system (2), or through interpreter programs (16). The RCS software (15) in turn can look for supplemental instructions, scripts, algorithms, and the like, in robotic control files (18) in the robot's onboard memory. The robotic SBDRL interface software can also look for supplemental instructions, scripts, algorithms and the like in SBDRL control files (19) in the robot's onboard memory.

In use, a remote browser command for robotic movement might initially result in server (3) sending a robotic movement interface web page (4) to remote Internet browser (6). The remote internet user might then send back CGI commands requesting robotic movement back to server (3), which is passed through CGI interface (7) to RCS software (15). RCS software (15) then executes the command to alter the location of robot (20). The RCS software is optionally able to draw upon supplemental information stored in onboard robotic control file (18) to assist in the process. The RCS software (15) also passes information as to the results of the movement command back through CGI interface (7) to server (3), which updates web page (4) on remote browser (6) to give the user feedback on the success of the movement request. Optionally, data from camera (21) (or other sensors) mounted onboard the robot are also sent back through RCS software (15), CGI interface (7), web server (3) to browser (6) to give the user an updated image of the robot's view.

A remote browser command to assess or modify the state of SBDRL devices local to the robot would be handled by one or more of the following. In one option, when robot (20) travels into range of the SBDRL devices (13), (14), the robot's onboard digital radio transceiver (10) detects devices (13) and (14), and relays the information back through the SBDRL interface software (8). Depending upon previously assigned instructions in SBDRL control file (19), the SBDRL interface software may be assigned to automatically query the registries of SBDRL devices (13) and/or (14) to determine their capabilities, and which of their functions are available for SBDRL controlled robotic use. SBDRL interface software (8) sends information as to the status of the SBDRL devices back through CGI interface (7) to web server (3), which, depending upon the status of HTML files (4) may update the remote browser (6) with information that the robot is within range of the local radio devices, and optionally give the local device status information. The remote Internet user can then directly control the robot or the SBDRL devices as appropriate.

Alternatively, the SBDRL control instructions (19) may direct the SBDRL interface software (8) to process the SBDRL information in several alternative ways.

If the standing orders in SBDRL control file (19) are to modify the state of SBDRL devices (13), (14) without requesting further input from remote internet site (6), then the processed output from (19) may be fed back to via the SBDRL interface software (8) to transceiver (10) to modify the state of SBDRL devices (13), (14).

If the standing orders in (19) are to modify the state of the robot (e.g. move in a different path, change the state of a robotic sensor, or activate an actuator), without requesting further input from remote internet site (6), then the processed instructions from (19) may be fed back to the RCS software (15) to modify the state of robot (20). For example, there could be a standing order in (19) that if the robot receives a message from a local SBDRL equipped fire alarm that the environment was too hot; the robot could activate a previously assigned set of commands to move out of the area.

If the standing orders in (19) are to automatically update an internal database (17) without requesting further Internet controller input, then the processed output from SBDRL interface software (8) may be fed back to database software (17). For example, there could be a standing order in (19) that a robot patrol an area, and automatically save data from local external SBDRL equipped sensors into a log for later analysis.

The standing orders stored in supplemental RCS control file (18) may be also be used in a manner similar to those just described for the SBDRL control file (19).

Example of an Internet controlled robot Interacting with a SBDRL Device

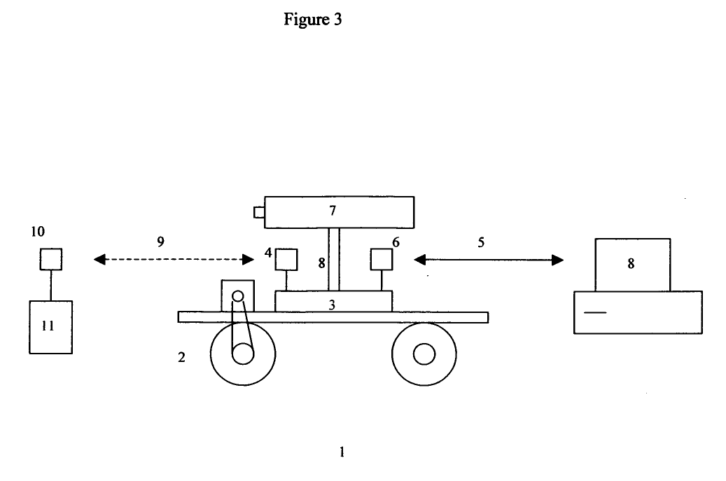

FIG. 3 shows a diagram of a mobile robot (1) that may be constructed based upon a battery powered chassis with motorize wheels (2), controlled by an Axis ETRAX 100 Developer Board (3) (Axis Communication AB, Lund, Sweden). This developer board, which may be used as the main robotic control unit, contains an ETRAX 100 32 bit central processor unit, 2 megabytes flash memory, and 8 megabytes ram. The software on this board runs using an embedded Linux operating system (uClinux based on 2.0.38 Linux). The developer board is connected to an Ericcson bluetooth module (4) by a RS232 serial port, driven by Axis bluetooth driver software. The developer board is additionally connected to a wireless Internet connection (5) (using a sprint PCS cell phone (6)) by a second RS232 serial port, driven by the onboard Axis “boa” web server software.

The robot's motorized wheels (2) are controlled through an interface to the Axis developer board's parallel port (3). The robot additionally has an onboard internet capable digital camera (Axis 2100 network camera (7)) that can take video pictures of the robots surroundings, compress them, and process the results into an HTML based web page via the camera's own separate onboard computer processor.

The Axis 2100 network camera (7) is interfaced to the Axis Developer Board (main robotic CPU) board (3) via an Ethernet connection (8). The web server onboard the Axis developer board, which has the main robotic CPU, is given overall control of the system. It is pre-programmed with HTML code (analogous to software file (4) from FIG. (2)) that initially responds to remote internet web browser web-page requests by sending a general “index.html” file that gives the robot's name, and status (power levels, bluetooth devices in-range, etc. as updated by CGI data), and a menu of possible user actions.

In this design demonstration, commands from the remote Internet web browser (8) to control SBDRL (bluetooth) devices are passed through the robot's web server CGI interface to a bluetooth input/output module, built into the Axis development board. The input/output module interprets this bluetooth command, and in-turn is directed to a bluetooth transceiver (4) mounted on the robot. In this simple design example, the bluetooth transceiver onboard the robot and the bluetooth transceiver (10) onboard the external SBDRL device (11) may be commanded to go into a bluetooth transmission state (9) that simulates a direct RS232 connection. This makes the two devices act as if they were directly connected by standard RS232 cable. With this scheme, an external bluetooth device (11) can be commanded to beep by simply sending a standard ASCII “Bell” character.

User requests for robotic movement are initiated by remote browser (8) sending a URL request for a robotic movement web page. This causes the server (3) to send a new web page to the user's browser (8). This page is divided into frames, one frame containing the robot movement control forms and bluetooth device interface forms, and a second frame containing a URL link to the Axis 2100 network camera, which sends picture data independently.

The robotic movement web page contains HTML forms to allow direct user control over the robot's motion, and additional HTML forms to allow the user to upload optional, prewritten, scripts to control the robot automatically for short periods of time. Normally, user requests for immediate and direct control are sent back to the robot's onboard web server (3), where they are passed though the server's CGI interface to a simple robotic control software (RCS) program. The RCS program is written as a CGI compliant “C” program executing in the /cgi-bin directory of the robot's main server. This program translates motion requests (forwards, backward, left turn and right turn) into commands that are sent out through the Axis board's parallel port (3) to the robot's motion control system (2)

The remote user also has the option of uploading one or more script files, analogous to files (18) and (19) from FIG. 2, that contain information (scripts) needed to run the RCS program and bluetooth interface program automatically. These script files may contain instructions to automatically query SBDRL devices as to their status, and automatically to upload commands to specific SBDRL devices. The script files may also contain instructions to control robotic movement in response to data downloaded from SBDRL devices, from data obtained directly from the robotic sensors, or both. These scripts may be anything from simple text files to complex programs.

An example of a simple robotic and SBDRL automatic control script file, written in XML format, is shown below:

<Move>

<Forward=“10”>
<Turn=“90”>

<Forward =“5”>

</Move>
<Pause=“10”/>
<YesBluetooth>

<Beep=“true”>
<Pause=“2”>
<Beep=“false>

</YesBluetooth>
<NoBluetooth>

<Turn=“360”>

</NoBluetooth>
<Move>

<Forward=“−5”>
<Turn=“−90”>
<Forward=“−10”>

</Move>

When the remote user uploads this file, and commands that it be executed, the robot will automatically move forward 10 spaces, turn right 90 degrees, move an additional five spaces, and wait 10 seconds. It will then attempt to make contact with a Bluetooth device. If it discovers a bluetooth compliant device <YesBluetooth>, it will send it a “beep” command for two seconds, and then turn off the remote device's beep. If it does not discover such a device <NoBluetooth>, it will spin in a circle. When either action is complete, the robot will then return to its original location.

As previously mentioned, in this design example, remote Internet users also can see what the robot is doing. To allow the remote user to see what the robot sees, the HTML form served by the robot's onboard web server directs the remote user's browser to divide the browser screen into frames, and for the video frame, get video data from a different URL controlled by second web server embedded in the Axis 2100 network camera itself. The video computer onboard the Axis 2100 camera handles user video requests, captures the video, and compresses it for internet transmission itself, without requiring additional processing from the main robotic computer onboard the Axis developer board that controls both the robot's web server and the other robotic control functions.

This serves to illustrate that the robotic system taught here need not contain only one computer. Rather, the computer powering the robot's web server, which is used as the primary input-output control means of the robot, can off-load computationally intensive processing tasks to secondary computer processors onboard the robot, as necessary.

Use of Zigbee SBDRL Devices for Robotic Location and Control

For the purposes of robotic location and instrument control, Zigbee (IEEE 802.15.4) technology is particularly useful. As discussed earlier, Zigbee is essentially a lower-power version of Bluetooth, but with greatly improved networking capability. Zigbee SBDRL devices can run for years from a single battery, can automatically form radio networks with other Zigbee devices, creating a wireless meshwork (network) of up to 64,000 radio-linked devices (nodes) that all transmit data to each other, and have a radio range of about 300 feet. The chips cost only a few dollars each, and are excellent for sensor tags and various types of radio controlled devices.

One aspect that is particularly useful for the present disclosure is that off-the-shelf (commercially available) Zigbee location technology has been developed. This location technology works by interrogating the Zigbee network, and determining which Zigbee nodes are receiving a particular Zigbee signal. This technology is capable of determining the precise location of a Zigbee device or tag to within a few feet.

Combining Zigbee and RFID Technology for Precise Robotic Navigation

Many different types of Internet controlled robots, which make use of short-range bidirectional digital radio links with local SBDRL devices for the purposes of navigation, can be constructed. One design example, discussed in more detail shortly, would create a nursing assistant robot with an overall design similar to that of other small, wheeled, hospital instrumentation such as IV stands, portable pulse and blood pressure monitors, etc. This type of robot can be easily wheeled out when needed, and easily stored when not needed.

For stability, most of the robot's heavy electronics—batteries, motors, and microcomputer (containing an on-board web server and a radio WiFi link to the internet), can be located in the robot's base. The rest of the robot, which can be mounted on a simple pole extending above the base, can consist of a handle (to allow the robot to be easily moved about when not turned on), a small utility basket, a Zigbee radio transceiver, an RFID radio transceiver, a small hand-held computer (PDA), here used as a combination display and control panel, and an internet video camera (such as a webcam). The overall goal is to create a robust, flexible, utilitarian design that is extremely inexpensive—ideally only a few thousand dollars per unit.

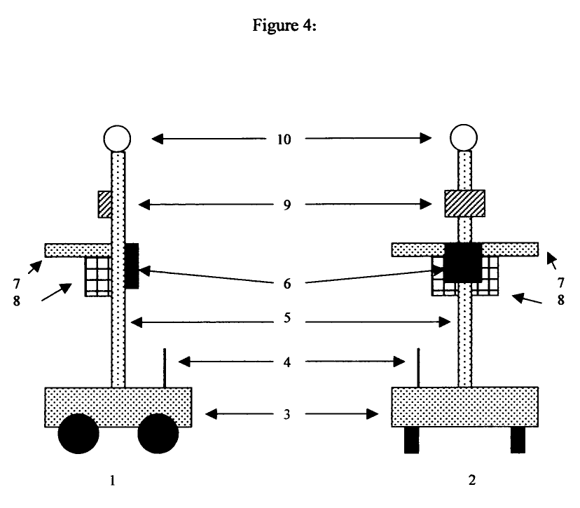

A diagram of this concept is shown in FIG. 4, which shows side (1) and front (2) views of this nursing assistant robot. In order to maintain maximum stability, the heavy batteries, motors, and electronics are contained in a base or chassis (3) close to the ground. Base or chassis (3) moves the robot by wheels or other mobility means (tank tracks, etc.). When wheels are used, it may be advantageous to connect the wheels to the robot's motors via an electrically operated clutch so that when the robot is turned off, the wheels turn freely, enabling the robot to be easily moved about the facility and manually repositioned for later use.

The robot usually will receive its highest-level commands from the Internet through a radio link (4), which will often be based on the commonly used IEEE 802.11 WiFi standard, but which can be any type of connection, short range or long range, wired, wireless, or even infrared. In this example, (4) shows a WiFi antenna. In order to keep the center of gravity of the robot low, the rest of the robot's components are mounted on a simple pole (5) protruding from base (3).

The robot will additionally have antenna or antennas (6) capable of receiving and transmitting SBDRL signals with local radio controlled devices, such as RFID tags, Zigbee controlled sensors, location transponders, and devices, Bluetooth controlled sensors and devices and other short range bidirectional digital controlled wireless sensors and devices. Since some of the radio controlled devices may consist of extremely short range RFID tags or very low power Zigbee or Bluetooth devices with a range of less than a few feet, it will often be advantageous to mount this antenna higher up the ground (here, a waist level antenna is shown), closer to the height level where many of these ultra-short range SBDRL devices are generally located.

In many cases, the robotic assistant will function to guide patients from one location to the next, or to transport supplies within a healthcare setting from one person to the next. To facilitate this purpose, the robot may additionally have a handle (7), and also a basket (8). Thus an elderly person may hold onto handle (7) and use the robot as a form of supplemental support while moving from one location to the next. Alternatively, as previously discussed, the wheels on base (3) may allowed to turn freely by an electrical clutch (which engages and disengages the wheels from the motors), and handle 7 may be used to manually reposition the robot.

In many cases, it will be advantageous for patients and other personnel close to the robot to be able to see and converse with the remote Internet operator of the robot. In this case, it may be advantageous to use the robot's WiFi or other Internet connection (4) to transmit and receive human interface data packets between the remote human operator and the local human robotic user. Although these data packets in turn can simply be converted into audio and visual signals by audiovisual equipment (such as a flat screen monitor and a speaker) that is electrically connected directly to the robot's control circuitry, and thus forms an integral part of the robot, it may be advantageous to use other ways to exchange human interface data packets.

Here, the robot's onboard SBDRL transceivers may be used to redirect or route data packets from the remote Internet user to local audio, visual, or text interface devices. For exchange of audiovisual human interface data packets, the Bluetooth SBDRL wireless standard is particularly useful because Bluetooth supports a comparatively high rate of data exchange, which is helpful for communicating audio and visual signals from the remote internet user to the local human operator. Here, the robot essentially acts like a self-propelled mobile Internet router. The router, once it is within range of the external audio or visual digital radio devices, can then exchange data packets between these devices and the remote Internet human operator.

In one simple embodiment, the local audio visual device may be a Bluetooth equipped personal digital accessory (PDA), which is essentially a small hand-held computer with a small flat screen display, a speaker, and optionally a microphone or camera. The PDA can pick up audiovisual signals from the remote human operator that were originally sent over the internet, transmitted to the robot via the robot's WiFi link, and then in turn rebroadcast by the robot in the form of a Bluetooth signal to the PDA. The PDA may be: 1) either completely separate from the robot; 2) attached to the robot via temporary means (e.g. Velcro strips, hung on the robot, etc.); 3) attached to the robot by screws or more permanent fixtures but not electrically connected to the robot; 4) attached to the robot, drawing electrical power from the robot, but getting all control signals by a SBDRL link; 5) attached to the robot and getting all power and control signals by a direct wired link to the robot. In many cases, it will be convenient to have the PDA attached to the robot via a robust but easy to detach system that would allow users easily remove the PDA from the robot in order to better view the remote operator. In many cases, it also may be advantageous if the robot has an electrical power source (plug) located near the PDA so that the PDA may be plugged into the robot to derive electrical power, and/or recharge the PDA's onboard batteries.

The robot will also typically contain one or more cameras (10) (webcams) capable of sending television signals from the robot's local environment to remote Internet operators. In order to get as broad a view of the surroundings as possible, it will often be advantageous to mount at least one of the webcams at the end of the pole, at a height roughly equal to that of an eye level view of a normal sized adult.

As previously discussed, the primary goal of this disclosure is to demonstrate technology that enables robots to automatically find a wide variety of things (people, medication, equipment) that usually don't have a fixed location. To do this, the robot can use a commercially available Chipcon CC243 1 Zigbee wireless location system, presently sold by Texas Instruments, which enables the exact location of a Zigbee wireless transmitting chip to be pinpointed to within a few feet (typically 3-6 feet). This approach uses automatic triangulation between a low-power wireless (Zigbee) transmitter chip located on the robot, wireless Zigbee chip relays with a known fixed location, and wireless position tags containing Zigbee transceivers which are worn by the patient or object that the robot should locate.

Many objects, such as medicine bottles and equipment, need to be found with much higher (pinpoint) accuracy—inches or less. Additionally a few foot accuracy still isn't enough to allow a robot to interact properly with patients and equipment. This disclosure demonstrates the feasibility of obtaining the necessary pinpoint positioning accuracy by means of a unique multiple-mode positioning system. In this approach, the Zigbee positioning engine is used to direct the robot to the general vicinity of the desired target (which contains a Zigbee transmitter). Once the robot has arrived to the general vicinity of the target, it can use a second fine-tuning location detection technique, based on one or more short-range RFID tags (which depending upon the tag in question can transmit from a few inches to a few feet), to achieve higher positioning accuracy.

Although there is no absolute requirement that the various radio-positioning transceivers (Zigbee chips, various RFID tags, etc.) all be combined into a single, unitized multi-mode “Positioning tag”, this combination does have a number of advantages. A single unitized positioning tag can be easily placed on a patient or object in a single step. Multiple-mode unitized SBDRL positioning tags thus offer the advantages of speed and simplicity, which are highly valued in most health care environments.

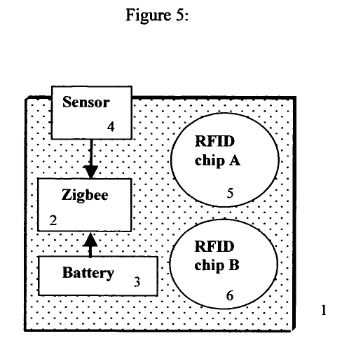

An example of such a unitized multiple-mode positioning tag is shown in FIG. 5. Here, multiple mode positioning tag (1) contains a Zigbee transceiver chip (2) powered by battery (3). Zigbee transceiver chip (2) may optionally be connected to additional sensors (4) which may be a patient operated call button intended to summon the robot or a nurse; physiological status monitors such as patient temperature, blood pressure, heartbeat, breathing, oxygen levels, or other physiological variable; equipment status monitors (such as the operating status of an intravenous pump); or equipment controllers (such as a bed adjust controller, an intravenous pump controller, etc.). The tag will usually also transmit appropriate patient identification codes.

Multiple mode positioning tag (1) will often also contain one or more RFID tags (5) and (6), which often will be short range RFID tags with different effective ranges. The robot can find the positioning tag's general location using a Zigbee location engine to locate the positioning tag's Zigbee transmitter (2). The robot can then move to the general vicinity of positioning tag (1). When the robot is in the general vicinity of tag (1), it can determine the location of positioning tag (1) more precisely by scanning for the location of the positioning tag's short range RFID chip-A (5). RFID chip-A will normally be selected to have a range of a few feet or more, long enough so that when the robot moves into the general region specified by the Zigbee location engine, the robot will have a high probability of being able to detect RFID chip-A (5).

The robot's scanning process for RFID chip-A can consist of small search movements around the location specified by the Zigbee location engine. Alternatively, the robot can scan for RFID-chip-A while in route to the destination specified by the Zigbee location engine, which will facilitate locating RFID-chip-A by triangulation methods. Alternatively, the robot can use a directional RFID detector to determine the direction of the RFID signal from RFID chip-A (5). Once the direction of RFID-chip-A is determined, the robot can then move in that direction.

As the robot moves closer to the location of positioning tag (1), the robot will eventually come within range of short-range RFID chip-B (6). RFID chip-B will normally have a significantly shorter radio communication range than the radio communication range of RFID-chip-A. The data obtained from detecting RFID chip-B can assist the robot in further determining the precise location of positioning tag (1). The robot can then use this information to either move closer to positioning tag (1), or alternatively the robot can use this information to determine that it is now close enough or too close to positioning tag (1), and stop or back off somewhat. Thus RFID-chip-A may have a range of three to nine feet (1-3 meters), and RFID chip-B might have a range of six inches to two feet (0.2 to 0.8 meters). Additional RFID chips with different effective ranges may also be added as needs dictate.

Although active RFID tags can be used for this purpose, it often will preferable to use passive RFID tags. This is because for this application, what are normally considered to be passive RFID tag disadvantages—very short range, and high dependence of the return signal on getting a good signal from the robot's RFID detector, are actually advantages when the RFID tag is being used as a short range position detector. By contrast, the longer range of active RFID tags, and their lower dependence on getting a good signal from the robot's RFID detector, is less useful for precise positioning purposes. As previously discussed, the positioning tag in FIG. 5 (1) can be either affixed to a patient or to equipment or medical supplies. If affixed to a patient, this positioning tag can serve as a Zigbee/RFID patient identification and location tag. It also can do much more. As previously discussed, it is likely that at a minimum, all patient tags will at least include a “summon” button (here shown as the “Sensor” (4)), which would allow a patient to page a robotic nursing assistant.

As previously discussed, many different types of positioning tags are possible. For example, one type of tag could also transmit patient vital signs. A different type of tag (designed for medical equipment) could transmit equipment data. A third type of tag could receive data from the Zigbee transmitter on the robot, and this tag would interface with various types of external equipment. As a result, the robot could approach the equipment in question, and use a radio signal to adjust the equipment.

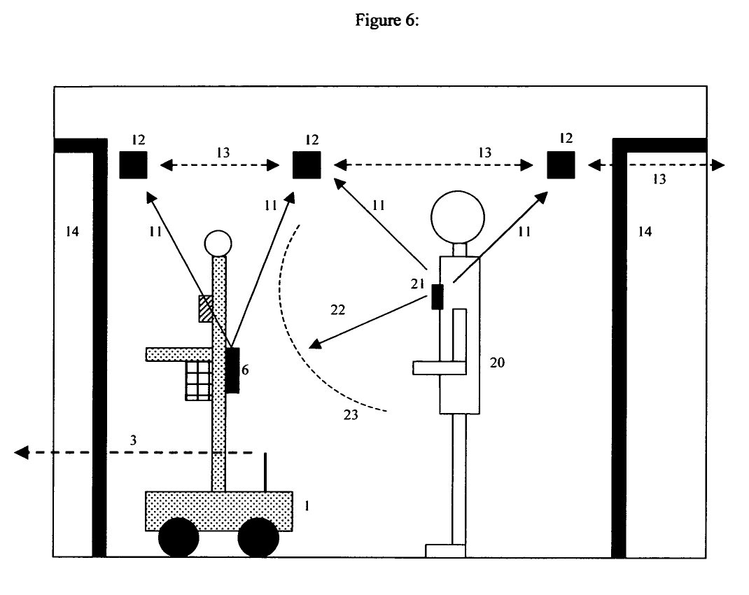

FIG. 6 shows how multiple wireless technologies can be combined to locate a staff member or patient (tag wearer). Here robot (1) from FIG. 4 is shown connected to the Internet by wireless WiFi link (3). The robot also contains antenna and electronics capable of detecting both Zigbee and RFID SBDRL wireless signals (6). The robot uses its onboard Zigbee electronics to establish Zigbee wireless links (11) with various local Zigbee location transponders (12), placed at multiple local locations, which to allow the robot's onboard Zigbee location system to compute the robot's relative location. The Zigbee location transponders (12) can also serve other purposes as well (sensors, equipment control), and can relay signals between each other, the robot, and other systems (such as the internet) via their Zigbee wireless links (13). To help visualize the relative scale of this setup, the robot (1) is shown interacting with a tag wearing patient (20) in a hallway in between two door openings (14).

Here the tag wearer (20) is wearing the positioning tag previously shown in FIG. 5. This positioning tag (21) contains both a Zigbee transmitter (with a range of up to about 300 feet) and one or more passive RFID-tags (with a ranges of about 1-10 feet). The Zigbee portion of the compound positioning tag continually interacts though Zigbee wireless signals (11) with Zigbee location transponders (12) placed at strategic locations around the health care facility. This Zigbee signal path allows the Zigbee location engine to define the approximate location of the tag wearer target (20), (21).

This commercially available Zigbee location technology can be used to determine the location of the robot in a health care facility, geriatric home, nursing home, or private residence. The Zigbee location technology examines the path that the robot's Zigbee signal takes as it traverses the healthcare facility's Zigbee network. After the location has been determined, both sets of location data (robot location, patient location) can be sent to the robot, which can process it into web pages, and send it to the nurses' web browser. Alternatively, the information can be sent to the nurse directly via the Zigbee network.

As previously discussed, the Zigbee location technology only has an accuracy of within a few feet. When the robot is close to its target (20), (21), the robot can use the signals from one or more very short range RFID tags to determine the patient's location to a very high degree (one foot or less) of precision. To do this, the patient positioning tag (21) will typically contain one or more very short-range RFID tags (often these will be passive RFID tags).

The robot thus uses the Zigbee location engine to move into the general vicinity of the patient or target (20). The robot can then use the several foot signal from a medium distance RFID tag (22) located on the patient's positioning tag (21) to determine the location of the target (20) to a still higher degree of accuracy. The robot can do this because the signal from medium distance RFID tag, which only has a range of a few feet (23), lets the robot know that the robot is now very close to its target. That is, when the robot gets within RFID range, it detects the RFID signal (23), and when it is outside of the RFID signal range, it does not detect the RFID signal. The robot can also use the signal from multiple RFID tags with varying range (not shown) to guide it to target (20), (21). In some cases, the robot may use detection of an extremely short range RFID tag to determine that the robot has approached the target (20) too closely. The robot can then back off until this extremely short range RFID signal is no longer detected.

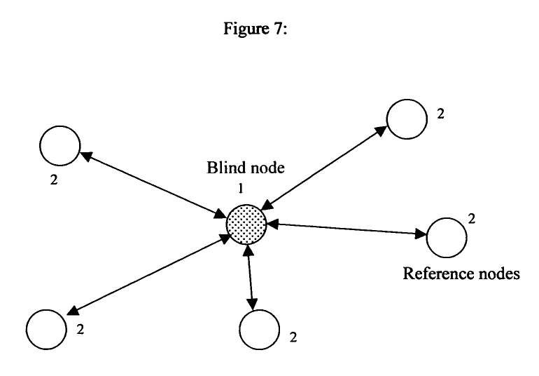

FIG. 7, based on an illustration from taken from FIG. 1 of the previously cited Chipcon-Texas Instruments CC2431 instruction manual AN042, shows how the CC2431 Zigbee location estimation system works. Here the “blind node” (1) can represent either the mobile robot or the robot's intended target (both the robot and its target will be located using this location estimation system). In either case, the position of the robot or the target is determined by radio triangulation using data obtained from multiple reference nodes (2) (designated as “Zigbee location transponders” elsewhere in this text) with known locations.

Robotic Interfaces:

The robot's onboard web server allows standard web browsers to control the robot. As a result, complex robotic control problems can be managed by designing user-friendly web pages. Each robot can have its own web page, and by flipping between web pages (for example, by using a tabbed web browser such as FireFox or Internet Explorer 7.0), a nurse or other remote Internet user can control multiple robots at once.

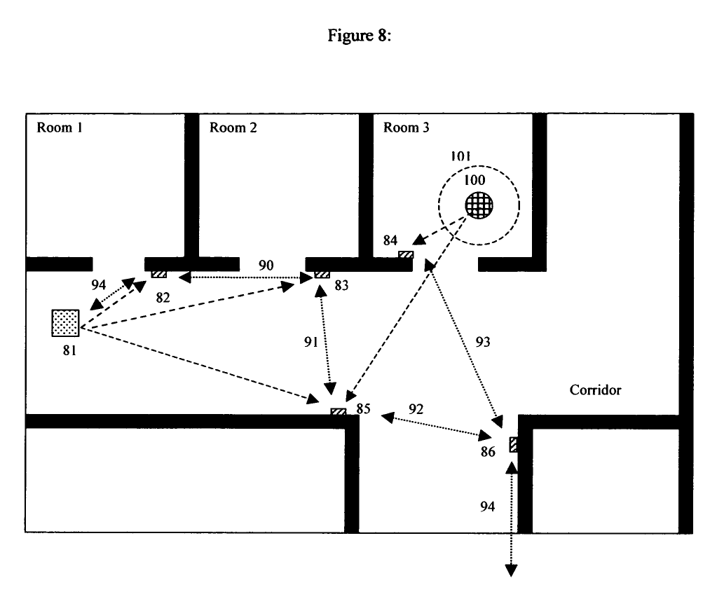

An additional advantage of web page interfaces is that the robot can produce different web pages depending upon what it is doing at the moment. For example, when a nurse or other operator simply wishes to get a rough overview of where the robot is presently located, the robot can send a overhead view web page to communicate this. To do this, robot can combine its pre-stored knowledge of the building's floor plan or layout, with its own location information as determined by the robot's relative location to nearby Zigbee devices with known location. The robot can also add information pertaining to the location of various potential tagged targets, since the location of these targets can also be determined relative to the target's location relative to nearby Zigbee devices with known location. Once determined, the location of the target can then be communicated to the robot via the building's Zigbee network. As a result, the robot can obtain the information needed to send a comprehensive position web page showing the building layout, its own location, and the location of various targets. This is shown in FIG. 8.

If the nurse desires to send the robot to a patient (to deliver medicine, or to have the patient follow the robot to a treatment room), the nurse can click on the patient's location on the web browser, and direct the robot to go to that location. The robot can use the Zigbee location information, in conjunction with previously entered building layout information that is stored in the robot's internal memory, to calculate how best to reach this patient's location. Once there, the robot can detect when it has arrived close to the correct patient by searching for the short-range RFID tag signal from the patient's compound position-tag.

FIG. 8 shows a robotic floor plan web page, with some additional annotation to better convey how radio signals are relayed around the facility. The robot (81) serves this and other web pages to the nursing station through the robot's onboard web server and a WiFi link. (Not shown).

In order for Zigbee location tacking to work, a number of fixed-position Zigbee location transponders (82, 83, 84, 85, 86) were previously put up at defined positions in the facility. These Zigbee location transponders are inexpensive battery-powered devices that can simply be fastened to defined locations in the facility. These fixed position relays serve as reference points, allowing the position of the mobile robot and the mobile patient (or medical equipment tags) to be located by the Zigbee tracking system.

Here robot 81 determines its location by triangulation from Zigbee location transponders (82, 83 and 85). The location of robotic target (100) (here assumed to be a patient wearing the tag shown in FIG. 6(20) and 6(21)) is determined by triangulation from Zigbee location transponders 84 and 85. Additionally, the Zigbee location transponders communicate with each other and form a Zigbee radio network by radio links (90, 91, 92, 93, 94) allowing information from any Zigbee node to be communicated to any desired point in the network. Using this Zigbee network, and the Zigbee location engine, the mobile robot knows both its own location, and the location of the target (100). In this example, the location of target (100) is determined by triangulation with Zigbee location transponders 84 and 85, and is communicated to the robot through the Zigbee radio network by the following Zigbee network links:

Zigbee location transponder 84 to Zigbee location transponder 86 by signal 93,

Zigbee location transponder 86 to Zigbee location transponder 85 by signal 92,

Zigbee location transponder 85 to Zigbee location transponder 83 by signal 91

Zigbee location transponder 83 to Zigbee location transponder 82 by signal 90

Zigbee location transponder 82 to the robot by signal 94.

As previously discussed, assuming that the location of the various Zigbee location transponders has previously been entered into the robot's memory, the robot can then use this location information, in conjunction with the information derived from the Zigbee location transponder network, to compute both the robot's location and the target's location relative to the facility layout (here also assumed to have been previously entered into the robot's memory), and generate a web page similar to that shown in FIG. 8. (The robot's web page generator program will usually not display the various Zigbee signal paths in order to avoid visually cluttering the web page).

In this simple interface example, if the nurse desired to send the robot to the patient (tag wearer 100) in room 3, the nurse might simply click on the robot, click on the patient, and click on a “goto” menu option. The robot would receive the command from the nurse's web browser, and then automatically navigate to the patient without any need for further input or guidance from the nurse.

When the robot gets in relatively close proximity to the patient, an RFID sensor onboard robot (81) would detect that the robot is within the desired range (a few inches to a few feet), here shown by dotted circle (101) of the RFID sensor mounted on the patient's tag (100), and signal the nurse that the robot has reached its destination, and stop moving. After the robot (81) signals that it has reached its destination, the robot can then serve other types of web pages optimized for telemedicine applications. If the nurse wishes to use the robot's onboard Zigbee transmitter to interface with and adjust local medical equipment, the robot's web server can send the appropriate medical equipment interface web pages (not shown).

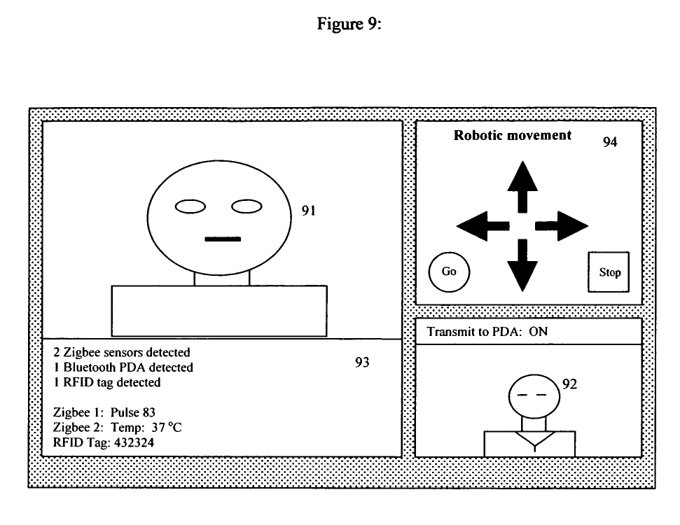

In many situations, the nurse may wish to communicate with a patient by a video link (video-conference/telepresence). Here the nurse can view the patient through the robot's onboard webcam (FIG. 4(10)), and the patient in turn may view the nurse through a small video screen (such as the PDA video screen previously shown in FIG. 4(9)) that is mounted on the robot. This allows the nurse to have “face to face” meetings with the patient. An example of a robotic telepresence web page is shown in FIG. 9.

In this example, in addition to transmitting basic patient ID information, the patient's positioning tag (previously shown in FIG. 5(1) and FIG. 6 (21)) is also transmitting patient vital signs from the tag's onboard sensors via the tag's Zigbee link FIG. 9 (93). The robot, in turn, is transmitting an audio and video signal from the doctor or nurse to the patient via a Bluetooth-equipped PDA, mounted on the robot. Here the patient's image (91) is shown on the upper left, and the image transmitted by the doctor or nurse (92) is shown on the lower right. Robotic movement controls (e.g. move forward, back, sideways) are shown on the upper right (94).

Hardware:

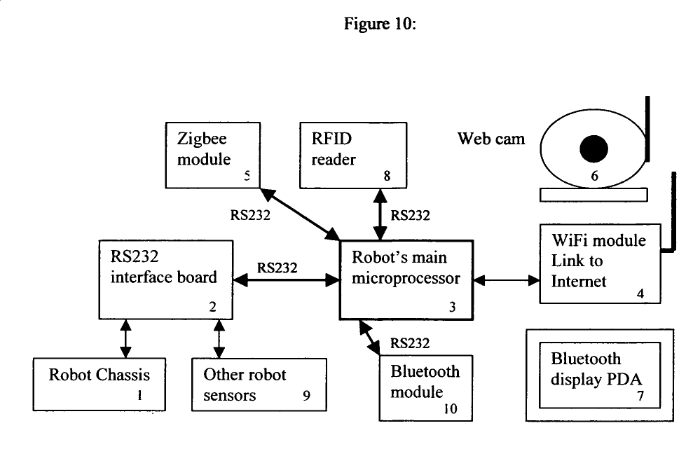

Robots designed according to the teaching of the present specification can be assembled by many different electrical connection schemes, and can use parts sold by many different companies. One particularly simple way to construct a robot according to FIG. 4 is to construct the robot from preassembled off-the-shelf modules that communicate using the old, well established, and simple serial RS232 communications interface and protocol. One possible electrical connection diagram, which can be used to construct the the robot shown in FIG. 4, is shown in FIG. 10.

The robot's various modules may be obtained from different sources. As an example, “Roboticsconnection.com”, Hoschton Georgia sells a number of suitable robotics chassis and control modules, which may be connected by RS232 connections. These components include: the Traxter robotic base (1), the serializer RS232 control board (2), the vortex x86-6071 LV PC104 control board (3) (which serves as the robot's main microprocessor, and also runs the robot's operating system and web server), and the vortex x86-6082 WiFi kit (4) which serves as the robot's main connection to the internet. Mobile robotic chassis (1) are also commercially available from other vendors, such as Lynx motion and MobileRobots.com. These vendors sell different types of pre-constructed robot bases (chassis), such as the P3-DX base (Mobile Robots), and the 4WD3 base (LynxMotion). Like the Traxter, these pre-assembled bases or chassis contain the basic robotic chassis, motor, and battery system in a ready-to-use form.

Suitable Zigbee location engines components and software (5), such as the CC2431 Zigbee location monitor, may be obtained from the Chipcon division of Texas Instruments.

Suitable robotic Internet web cameras, such as the DCS-5300G audio webcam (6), may be obtained from D-link Corporation.

Suitable personal digital assistants (PDA) devices (7) with suitable display screens and suitable SBDRL wireless links, such as Bluetooth links, can be obtained from multiple vendors. One suitable model is the Dell AXIM X-51.

Suitable passive RFID tags for the position tag (FIG. 5) can be obtained from Intermec Corporation, or many other different vendors.

Suitable RFID tag readers (8) can also be obtained from multiple vendors. One highly capable portable (handheld) RFID tag reader, which is useful because it can read many different RFID tag frequencies and protocols, communicate its results by an RS232 link, and is small enough to be incorporated into a battery powered robot is the Symbol MultiTag directional RFID tag reader.

Other robot sensors (9), including vision systems, sound sensors, infrared sensors, touch sensors, etc. may be obtained from multiple vendors, including the previously discussed robot chassis vendors. Similarly other SBDRL wireless interfaces, such as Bluetooth transceivers (10), are now standard commodities that can be obtained from multiple vendors.

As previously discussed, although there are multiple ways of electrically connecting these different robot components (microprocessor modules, motion control modules, web server modules, sensor modules, and various RFID, Bluetooth, Zigbee, and wireless modules) RS232 connections (wired or wireless) have the advantage of extreme simplicity. This is because all of these modules are commercially available in preassembled forms that communicate via a standard RS232 interface. Thus, to minimize complexity and reduce expense, it is often advantageous to build the robot around pre-assembled RS232 connection boards, such as the RoboticsConnection “serializer RS232 control board.

Using this simple technique, different preassembled electronics modules can be wired together to produce a robotic wiring diagram similar to that shown in FIG. 10. Note that in this particular diagram, some modules are connected to the robot's main microprocessor, and each other, by physical (wired) RS232 connections. Arrows show these. Other modules, such as the Web cam (6) can operate as stand alone modules. Still other modules, such as the Bluetooth display PDA (7) can be connected to the main robot microprocessor (3) by either a wireless Bluetooth RS232 link, a wired RS232 link, or other connection such as a USB link.

To reduce complexity, the robot's “eye” (Web cam) (6) can be a stand-alone unit with its own wireless web server. This can run independently of the rest of the robot. The remainder of the robot can consist of a miniature PC (PC104) board (3) running the operating system (Linux or Windows); the robot's Apache web server, MySQL database, and Perl scripting language (which in turns run specific robotic control routines). As previously discussed, almost everything can be tied together by standard RS232 links, which in turn are controlled by software, such as appropriate Perl scripts.

As previously discussed, the Bluetooth PDA (Pocket PC) (7) can be mounted on the robot near the webcam, and used to show the image and sound of the nurse to the patient. Alternatively the Bluetooth interface can be some other type of device, such as a wireless headset, or some sort of communication device not electrically connected to the robot, such as a Bluetooth controlled audiovisual projector. As previously discussed, in the case where Bluetooth display PDA is mounted on the robot by a non-electrical connection such as a hook or snap, it may be convenient for the robot to have an electrical power plug located somewhere on the robot's chassis so that the batteries in PDA (7) may be recharged while the robot is operating.

Software:

As previously discussed, the robot control software can be based on a standard open-source framework. This framework can include the Apache web server, the MySQL database, and the Perl scripting language. This standard three-application framework is used for much Internet programming, and usually is abbreviated as “AMP” (Apache, MySQL, Perl). This AMP software package can run on various operating systems, including Linux and various versions of Microsoft windows.

This approach has a number of advantages. A large number of people are familiar with these applications, which simplifies robotic programming efforts. A second advantage is that it is extremely easy to write powerful applications in Perl (or related languages used commonly on the internet, such as Python, PHP, Ruby etc.), and indeed many powerful Internet and robotics control applications, written in Perl, are available for use on an open-source basis. The overall software design will be similar to that previously described in FIG. 2 of U.S. Pat. No. 6,658,325 (columns 9 and 10) (8-11), which is the original parent application to this disclosure.

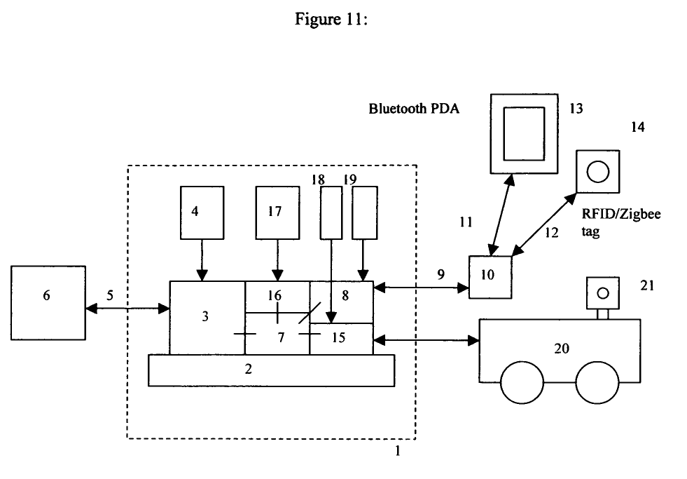

FIG. 11 shows the general structure of the software (1) onboard the robot. The robot's computer processor is a multitasking operating system (2) which runs a separate web server software process (3), The web server (3) is able to read HTML files (4) stored in the robot's onboard memory, and transmit them via long-distance telecommunications link (5) and HTTP protocol to remote web browser (6). Web server (3) also has CGI interfaces (7). These CGI interfaces are capable of sending and receiving data from most or all of the other software processes running onboard the robot. Also running on the robot's operating system (2) is wireless (RFID, Bluetooth, Zigbee) interface software (8) to handle input/output (9) from the robot's onboard wireless transceivers (10), capable of establishing links (11), (12) with external wireless devices (13), (14) such as RFID tags, Zigbee tags, Zigbee location sensors, multi-mode Zigbee/RFID positioning tags, and Bluetooth devices. When the robot's internet based operator wishes to send images of the operator over the internet to the local users of the robot, some of these wireless devices can be equipped with vision screens and or speakers. These devices may be Bluetooth equipped personal digital accessories (13), Bluetooth microphone/earphone headsets, etc.

Additionally running on the robot's operating system (2) are robotics control software (RCS) (15) which controls various robotics hardware such as motion control motors, onboard sensors, onboard mechanical manipulators, power management, and the like. Also running (16) are additional JAVA, PERL, PYTHON, C, etc., interpreters and compilers as needed to run various control instructions. These control instructions can include instructions to use the location information obtained from the Zigbee network, and RFID sensors, to direct the robot to appropriate locations, as well as to provide the information needed to send appropriate robotic control web pages to the remote internet user.

In use, the robot's web server (3) establishes contact over communications link (5) with remote Internet browser (6). The robot's web server (3) transmits HTML file (4) to remote browser (6), and receives back requests for additional web pages and CGI commands from remote browser (6). The robot's web server (3) directs the CGI commands through CGI interface (7) to various robotic programs or files, depending upon the robot's state and the nature of the commands sent from the remote browser. Remote browser commands are handled directly by the robot's onboard web server (3), which sends additional web pages from HTML file (4) back to remote browser (6). Remote browser CGI commands for general robotics intelligence or additional web page functionality (for example, to read from or update a robotic database) are passed through CGI interface (7) to other programs (e.g. database systems, such as SQL servers, and the like, which can be used to store facility layout information such as floor plans) (17) in the robot's onboard memory, also running under operating system (2). Other interpreters (JAVA, PERL, etc.) may optionally run these other programs (17). (16), and robotic control files (18) as needed.

In this example, the nursing assistant robot is capable of performing a number of different healthcare functions, including the following:
1: Allow a nurse to find a person (patient) in an arbitrary location
   The patient's location can be determined by the interactions between the patient's RFID/Zigbee tag and the Zigbee position-sensing network.
   The robot's location can also be determined by the interactions between the robot's onboard Zigbee transmitter, and the Zigbee position sensing network
   The position of both the patient and the robot, as reported by the Zigbee position-sensing network, can be displayed on the nurse's web browser.
   Using the web browser, the nurse can direct the robot to find the patient.
   Alternatively, the patient can use a tag “call button” to request robotic attention.
   The robot can use the Zigbee positioning system to navigate to the general vicinity of the patient.
   Once the robot is in the general vicinity of the patient, the robot can use its RFID tag sensors, and the RFID portion of the patient's combination RFID/Zigbee tag, to identify more precisely where the patient is located.
2: After reaching the patient, the robot can show image and sound of the nurse-operator to the patient, and relay the image of the patient (with sound) to the nurse-operator.
   Patient image and sound can be transmitted to the nurse via a standard WiFi wireless webcam mounted on the robot.
   Nurse image and sound can be transmitted from the nurse to the patient via a webcam on the nurse's computer, transmitting data to the robot, and from the robot to a Bluetooth equipped PDA mounted on the robot using a Bluetooth link.
   The patient's ID code (as determined by the RFID portion of the patient's compound RFID-Zigbee tag) can be detected by the robot and sent to the nurse's web browser.
3: The nurse can direct the patient to follow the robot to a third arbitrary destination location, identified by the location of a third compound RFID-Zigbee tag.
   The nurse can use the web browser to select the destination location.
   The robot can lead the patient to the location. The robot will continually sense distance to the patient by monitoring the RFID tag of the patient's combination RFID-Zigbee tag, and can automatically stop moving if distance to the patient is large enough to move out of a roughly 3-foot RFID-range.
   The robot can judge success at reaching the destination by monitoring its position relative to the third destination location RFID-Zigbee tag.
   The nurse can use her web browser to confirm that the patient has arrived.

1: A robotic navigation system,
said system comprising a mobile robot,
said robot having onboard telecommunications means to establish short-range bi-directional digital radio links with a plurality of local known location external digital radio controlled devices;
wherein said robot determines it's location by using said local short-range bidirectional digital radio links to determine the relative distances between said robot and one or more of said local known location digital radio controlled devices.

2: The robotic navigation system of claim 1,
In which said robot's memory additionally contains a map of said robot's local environment,
And in which said robot navigates by combining information from its map of said local environment with said location information obtained by determining the relative distances between said robot and one or more of said local known location digital radio controlled devices.

3: The robotic navigation system of claim 1, in which, sad robot has telecommunications means to link said robot to the Internet using the TCP/IP protocol.

4: The robotic navigation system of claim 1, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location object.

5: The robotic navigation system of claim 1, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location object,
wherein said bidirectional digital radio links between said unknown location object and said robot are direct links.

6: The robotic navigation system of claim 1, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location objects,
wherein the location of said unknown location objects is determined by short range bidirectional digital radio links between said unknown location objects and said local known location external digital radio controlled devices.

7: The robotic navigation system of claim 1, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location objects,
wherein said bidirectional digital radio links between said unknown location object and said robot are direct links,
and in which said unknown location object contains an RFID tag, a microprocessor controlled digital radio transceiver, or a combination of one or more RFID tags and microprocessor controlled digital radio transceivers.

8: The robotic navigation system of claim 1, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location objects,
wherein the location of said unknown location objects is determined by short range bidirectional digital radio links between said unknown location objects and said local known location external digital radio controlled devices,
and in which said unknown location object contains an RFID tag, a microprocessor controlled digital radio transceiver, or a combination of one or more RFID tags and microprocessor controlled digital radio transceivers.

9: A robotic navigation system,
said system comprising a mobile robot, and a telecommunications means to link said robot to the Internet using the TCP/IP protocol;
said robot containing an onboard web server;
said robot being controlled by commands sent over the internet;
said robot having onboard telecommunications means to establish short-range bi-directional digital radio links with a plurality of local known location external digital radio controlled devices;
wherein said robot determines it's location by using said local short-range bidirectional digital radio links to determine the relative distances between said robot and one or more of said local known location digital radio controlled devices.

10: The robotic navigation system of claim 9,
In which said robot's memory additionally contains a map of said robot's local environment,
And in which said robot navigates by combining information from its map of said local environment with said location information obtained by determining the relative distances between said robot and one or more of said local known location digital radio controlled devices.

11: The robotic navigation system of claim 9, in which said local known location digital radio controlled devices are selected from the group consisting of Zigbee devices, Bluetooth devices, RuBee devices, Z-wave devices, and RFID tags.

12: The robotic navigation system of claim 9, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location object.

13: The robotic navigation system of claim 9, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location object,
wherein said bidirectional digital radio links between said unknown location object and said robot are direct links.

14: The robotic navigation system of claim 9, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location objects,
wherein the location of said unknown location objects is determined by short range bidirectional digital radio links between said unknown location objects and said local known location external digital radio controlled devices.

15: The robotic navigation system of claim 9, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location object,
wherein said bidirectional digital radio links between said unknown location object and said robot are direct links,
and in which said unknown location object contains an RFID tag, a microprocessor controlled digital radio transceiver, or a combination of one or more RFID tags and microprocessor controlled digital radio transceivers.

16: The robotic navigation system of claim 9, in which said system additionally contains one or more unknown location objects,
said unknown location objects being local to the robot,
said unknown location objects containing communications means to establish short-range bidirectional digital radio links,
wherein said robot uses it's location information obtained from said known location external digital radio controlled devices, and information obtained from said unknown location object's short-range bidirectional digital radio links, to navigate to the vicinity of the unknown location objects,
wherein the location of said unknown location objects is determined by short range bidirectional digital radio links between said unknown location objects and said local known location external digital radio controlled devices,
and in which said unknown location object contains an RFID tag, a microprocessor controlled digital radio transceiver, or a combination of one or more RFID tags and microprocessor controlled digital radio transceivers.

17: A unitized location determination device,
said device containing a microprocessor controlled transceiver capable of establishing short-range bidirectional digital radio links with a plurality of local microprocessor controlled transceivers using a first communications protocol;
said device additionally containing one or more RFID tags,
said microprocessor controlled transceiver and said RFID tags being packaged in a unitized device so that the device may be affixed to an object as a single unit;
said RFID tags sending data using an alternative communications protocol, and wherein said RFID tags have an effective radio communications range substantially different from said microprocessor controlled transceiver communicating on said first communications protocol;
in which the location of said location determination device is determined by using information obtained by the interaction of said microprocessor controlled transceiver device communicating on said first communications protocol with one or more external microprocessor controlled transceivers with a known location;
and in which the location of said location determination device is further determined by using information obtained from the interaction of said RFID tags with an external RFID tag reader.

18: The device of claim 17, in which said device additionally contains one or more sensors capable of detecting environmental conditions on or near the device, and communicating the status of said environmental conditions via short range bidirectional digital radio links.

19: The device of claim 17, in which said device is used to monitor the status of a patient, and in which said device additionally contains one or more sensors capable of detecting the condition of said patient;
said sensors being selected from the group consisting of temperature monitors, heart rate monitors, respiration monitors, oxygen level monitors, or other monitor of patient physiological status;
in which said device communicates the status of said patient via short range bidirectional digital radio links.

20: The device of claim 17, in which said RFID tags are passive RFID tags, and in which said microprocessor controlled transceiver communicates using communications protocols selected from the group consisting of Bluetooth, Zigbee, RuBee, or Z-wave protocols.
